(19) United States
(12) Patent Application Publication
(10) Pub. No.: US 2012/0012684 A1
(43) Pub. Date: Jan. 19, 2012

(54) MULTI-MODE PRESSURE CONTROL AND SENSING SYSTEM

(76) Inventors: Michael J. Mansheim, Burnsville, MN (US); Glan W. Davidson, Rosaville, MN (US); Eric J. Finstad, Rogers, MN (US); Thomas E. Pauly, Zimmerman, MN (US); Bradley K. Voigt, Maple Lake, MN (US); Gerard L. Lehman, Ghamplin, MN (US); Mauricio E. Murillo-Gonzalez, Coon Rapids, MN (US); Jeromy D. Horning, Albertville, MN (US)

(21) Appl. No.: 13/258,571

(22) PCT Filed: Mar. 24, 2010
(86) PCT No.: PCT/US10/28397

§ 371 Date: Sep. 22, 2011

Related U.S. Application Data
(60) Provisional application No. 61/163,592, filed on Mar. 26, 2009.

(51) Int. Cl. B05B 1/00

(52) U.S. Cl. 239/600

(57) ABSTRACT

A single sprayer 12 is allowed to run in two completely different operating modes, thereby becoming suitable for medias controlled best by either system pressure or by flow rate. This provides the user with the ability to apply a wider range of products without incurring the higher cost of two separate systems.

### TECHNICAL FIELD

This application claims the benefit of U.S. application Ser. No. 61/163,592, filed Mar. 26, 2009, the contents of which are hereby incorporated by reference.

### BACKGROUND ART

### Disclosure of the Invention

The instant invention enables an airless sprayer to detect the absence or presence of a high-pressure pump and to automatically switch algorithms to accordingly control either fluid pressure or fluid flow.

A magnetic reed switch sensor is installed in the Graco® Pro-Connect™ pump “receiver” and is connected to the appropriate input on the pressure control board. Three small magnets are installed in the high-pressure paint pump to trigger that reed switch when this pump is installed. More than one magnet is used so that the sensor is more tolerant of the pump's rotational alignment.

To prevent zones of insensitivity from being created between the magnets, the magnets must be installed with consistent polarity, and the switch must have sufficient axial separation from them.

The control board's microcontroller software has two distinct running modes depending on the signal from the reed switch. When magnets are detected, it runs the high-pressure pump in a closed-loop control mode until the user-selected system pressure is reached—up to the system rated maximum pressure rating of (for example) 3,300 psi.

When magnets are not detected, the pump is run in one of the three open-loop, user-selected Flow control modes:
Flow 3—runs the pump continuously;
Flow 2—a somewhat reduced flow mode made possible by pulsing the current to the drivetrain clutch in a predetermined duty cycle;
Flow 1—a mode with greater flow reduction, resulting from pulsing the clutch in a duty cycle with a higher proportion of “off-time”.

In these modes, the control board limits pressure to the 1,000 psi WPR of a low-pressure pump. And, since the applicator (spray gun, etc.) does not have a flow control valve, the board runs the pump only if the user activates a switch near the applicator, or the “prime” switch mounted on the control box.

The instant invention allows a single sprayer to run in two completely different operating modes, thereby becoming suitable for medias controlled best by either system pressure or by flow rate. This provides the customer with the ability to apply a wider range of products without incurring the higher cost of two separate systems.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a front view of a sprayer utilizing the instant invention.

FIG. 2 is a high pressure pump utilizing the instant invention.

FIG. 3 is a cross-sectional view taken along line 3-3 of FIG. 2.

FIG. 4 shows the reed switch installed in the receiver.

FIG. 5 shows a cross-section along line 5-5 of FIG. 1.

FIG. 6 is a more detailed view of the pump installed in the receiver.

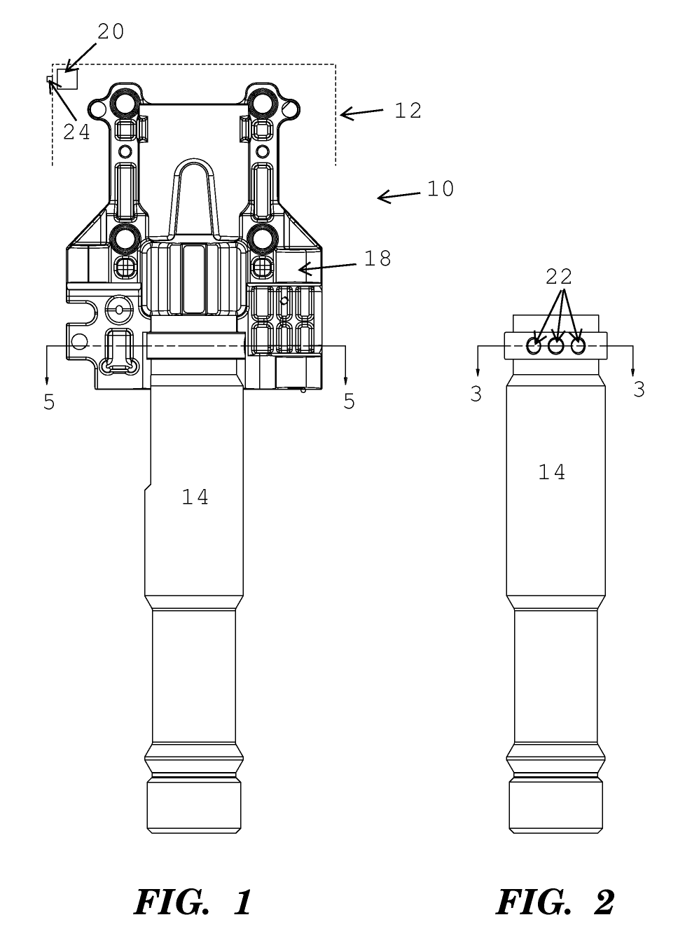

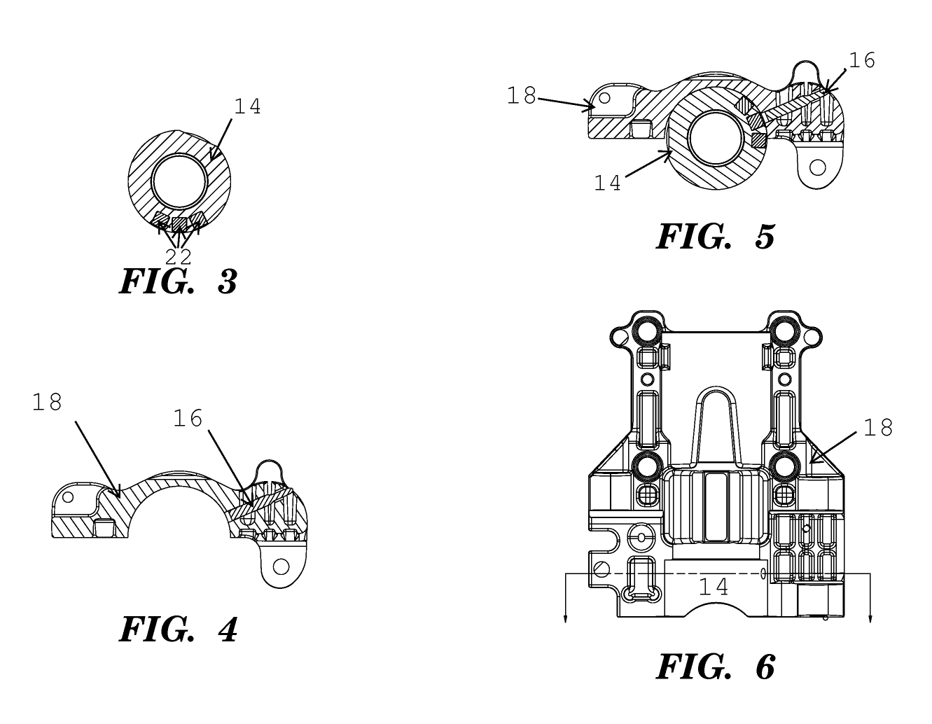

### BEST MODE FOR CARRYING OUT THE INVENTION

The instant invention, generally 10, enables an airless sprayer 12 to detect the absence or presence of a high-pressure pump 14 and to automatically switch algorithms to accordingly control either fluid pressure or fluid flow.

A magnetic reed switch sensor 16 is installed in the Graco® Pro-Connect™ pump “receiver” 18 and is connected to the appropriate input on the pressure control board 20. Three small magnets 22 are installed in the high-pressure paint pump 14 to trigger that reed switch 16 when this pump 14 is installed. More than one magnet 22 is used so that the sensor 16 is more tolerant of the pump's rotational alignment.

To prevent zones of insensitivity from being created between the magnets 22, the magnets must be installed with consistent polarity, and the switch 16 must have sufficient axial separation from them.

The control board's 20 microcontroller software has two distinct running modes depending on the signal from the reed switch. When magnets 22 are detected, it runs the high-pressure pump 14 in a closed-loop pressure control mode until the user-selected system pressure is reached—up to the system rated maximum pressure rating of (for example) 3,300 psi.

When magnets 22 are not detected, the pump is run in one of the three open-loop, user-selected Flow control modes:
Flow 3—runs the pump continuously;
Flow 2—a somewhat reduced flow mode made possible by pulsing the current to the drivetrain clutch in a predetermined duty cycle;
Flow 1—a mode with greater flow reduction, resulting from pulsing the clutch in a duty cycle with a higher proportion of “off-time”.

In these modes, the control board 20 limits pressure to the 1,000 psi WPR of a low-pressure pump. And, since the applicator (spray gun, etc.) does not have a flow control valve, the board runs the pump only if the user activates a switch near the applicator, or the “prime” switch 24 mounted on the control box 20.

The instant invention allows a single sprayer 12 to run in two completely different operating modes, thereby becoming suitable for medias controlled best by either system pressure or by flow rate. This provides the customer with the ability to apply a wider range of products without incurring the higher cost of two separate systems.

It is contemplated that various changes and modifications may be made to the sprayer without departing from the spirit and scope of the invention as defined by the following claims.

1. In a sprayer for application of coating material, said sprayer having a controller and a releasable receiver for allowing the quick interchange and replacement of the pump therein, the improvement comprising a sensor located in said receiver for detecting the presence of a pump having certain characteristics and a trigger located on a pump having certain characteristics.

2. The sprayer of claim 1 wherein said controller selects from multiple modes of operation depending on the presence of said trigger.

3. The sprayer of claim 1 wherein one of said modes comprises a constant pressure mode which controls pressure to a user-selectable setpoint.

4. The sprayer of claim 1 wherein one of said modes comprises a constant flow mode which controls fluid flow to a user-selectable setpoint.
